(19) United States
(12) Patent Application Publication
(10) Pub. No.: US 2015/0012855 A1
(43) Pub. Date: Jan. 8, 2015

(54) PORTABLE DEVICE FOR PROVIDING COMBINED UI COMPONENT AND METHOD OF CONTROLLING THE SAME

(71) Applicant: Samsung Electronics Co., Ltd., Suwon-si (KR)

(72) Inventors: Sung-Joon WON, Seongnam-si (KR); Bo-Keun KIM, Suwon-si (KR)

(21) Appl. No.: 14/322,242

(22) Filed: Jul. 2, 2014

(30) Foreign Application Priority Data
Jul. 8, 2013 (KR) 10-2013-0079769

(51) Int. Cl. G06F 3/0483; G06F 3/0488; G06F 3/0481

(52) U.S. Cl. CPC G06F 3/0483; G06F 3/04817; G06F 3/0488
USPC 715/765

(57) ABSTRACT

A method of controlling a portable device providing a combined User Interface (UI) component is provided. The method includes displaying a page on a touch screen, displaying a combined UI component of a collapsed state including one or more page indicators on the touch screen, detecting an expansion gesture of changing the combined UI component of the collapsed state into an expanded state, and when the expansion gesture is detected, changing the combined UI component of the collapsed state into the expanded state and displaying the combined UI component of the expanded state on the touch screen.

### CROSS-REFERENCE TO RELATED APPLICATION(S)

This application claims the benefit under 35 U.S.C. §119(a) of a Korean patent application filed on Jul. 8, 2013 in the Korean Intellectual Property Office and assigned Serial number 10-2013-0079769, the entire disclosure of which is hereby incorporated by reference.

### TECHNICAL FIELD

The present disclosure relates to a portable device and a method of controlling the same. More particularly, the present disclosure relates to a User Interface (UI) provided in the portable device.

### BACKGROUND

Currently, technologies for portable devices are rapidly being developed. Particularly, various applications are provided to the portable device. The portable device provides a useful service to a user through the application.

The portable device may display a page showing various items. The page may correspond to a plurality of pages. The plurality of pages may be switched and then displayed on a screen of the portable device. Icons corresponding to the plurality of pages are generally displayed on the screen of the portable device. The plurality of pages may be switched and then displayed according to selections of the icons.

According to the related art, the icons perform only a function of switching and displaying the plurality of pages on the screen. As a result, the related art has a problem of providing only a function of switching and displaying the plurality of pages on the screen. Further, since the plurality of pages are merely switched, the user cannot know which content is included in each page.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a portable device for providing a combined User Interface (UI) component in which a collapsed state and an expanded state are combined and a method of controlling the same.

In accordance with an aspect of the present disclosure, a method of controlling a portable device providing a combined UI component is provided. The method includes displaying a page on a touch screen, displaying a combined UI component of a collapsed state including one or more page indicators on the touch screen, detecting an expansion gesture for changing the combined UI component of the collapsed state into an expanded state, and when the expansion gesture is detected, changing the combined UI component of the collapsed state into the expanded state and displaying the combined UI component of the expanded state on the touch screen.

In accordance with another aspect of the present disclosure, a portable device providing a combined UI component is provided. The portable device includes a controller configured to display a page on a touch screen, to display a combined UI component of a collapsed state including one or more page indicators on the touch screen, to detect an expansion gesture for changing the combined UI component of the collapsed state into an expanded state, and, when the expansion gesture is detected, to change the combined UI component of the collapsed state into the expanded state and display the combined UI component of the expanded state on the touch screen, and the touch screen configured to display the page.

According to an embodiment of the present disclosure, there is an effect of providing a combined UI component in which a collapsed state and an expanded state is combined.

According to an embodiment of the present disclosure, there is another effect of changing a combined UI component of a collapsed state into a combined UI component of an expanded state and displaying the combined UI component of the expanded state when an expansion gesture is detected.

According to another embodiment of the present disclosure, there is an advantage of changing the combined UI component from the expanded state to the collapsed state when a collapse gesture is detected.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram schematically illustrating a portable device according to an embodiment of the present disclosure:

FIG. 2 is a front perspective view of a portable device according to an embodiment of the present disclosure;

FIG. 3 is a rear perspective view of a portable device according to an embodiment of the present disclosure;

FIG. 4 is a flowchart illustrating a method of controlling a portable device that provides a combined User Interface (UI) component according to an embodiment of the present disclosure;

FIGS. 5A and 5B illustrate screens showing combined UI components according to various embodiments of the present disclosure;

FIGS. 6A, 6B, 6C, 6D, 6E, 6F, 6G, 6H, 61, and 6J illustrate screens showing combined UI components according to a first example of the present disclosure;

FIG. 7 illustrates a screen according to the related art;

FIGS. 8A and 8B illustrate screens showing combined UI components according to the second example of the present disclosure;

FIGS. 9A and 9B illustrate screens showing combined UI components according to a third example of the present disclosure;

FIG. 10 is a flowchart illustrating a method of controlling a portable device that provides a combined UI component according to an embodiment of the present disclosure;

FIGS. 11A, 11B, and 11C illustrate screens showing combined UI components according to an embodiment of the present disclosure;

FIGS. 12A, 12B, and 12C illustrate screens showing combined UI components according to a fourth example of the present disclosure;

FIGS. 13A and 13B illustrate screens showing combined UI components according to a fifth example of the present disclosure;

FIGS. 14A, 14B, 14C, 14D, and 14E illustrate screens showing combined UI components according to a sixth example of the present disclosure;

FIGS. 15A, 15B, 15C, and 15D illustrate screens showing combined UI components according to a seventh example of the present disclosure;

FIGS. 16A, 16B, and 16C illustrate screens showing combined UI components according to an eighth example of the present disclosure;

FIGS. 17A, 17B, 17C, and 17D illustrate screens showing combined UI components according to a ninth example of the present disclosure; and

FIGS. 18A, 18B, 18C, and 18D illustrate screens showing combined UI components according to a tenth example of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While terms including ordinal numbers, such as “first” and “second,” etc., may be used to describe various components, such components are not limited by the above terms. The terms are used merely for the purpose to distinguish an element from the other elements. For example, a first element could be termed a second element, and similarly, a second element could be also termed a first element without departing from the scope of the present disclosure. As used herein, the term “and/or” includes any and all combinations of one or more of the associated listed items.

The terms used in this application is for the purpose of describing particular various embodiments only and is not intended to be limiting of the disclosure. As used herein, the singular forms are intended to include the plural forms as well, unless the context clearly indicates otherwise. Terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An apparatus according to an embodiment of the present disclosure corresponds to a personal computer, a portable device, or a smart TV. However, although the portable device will be described hereinafter as an example, the present disclosure is not limited thereto.

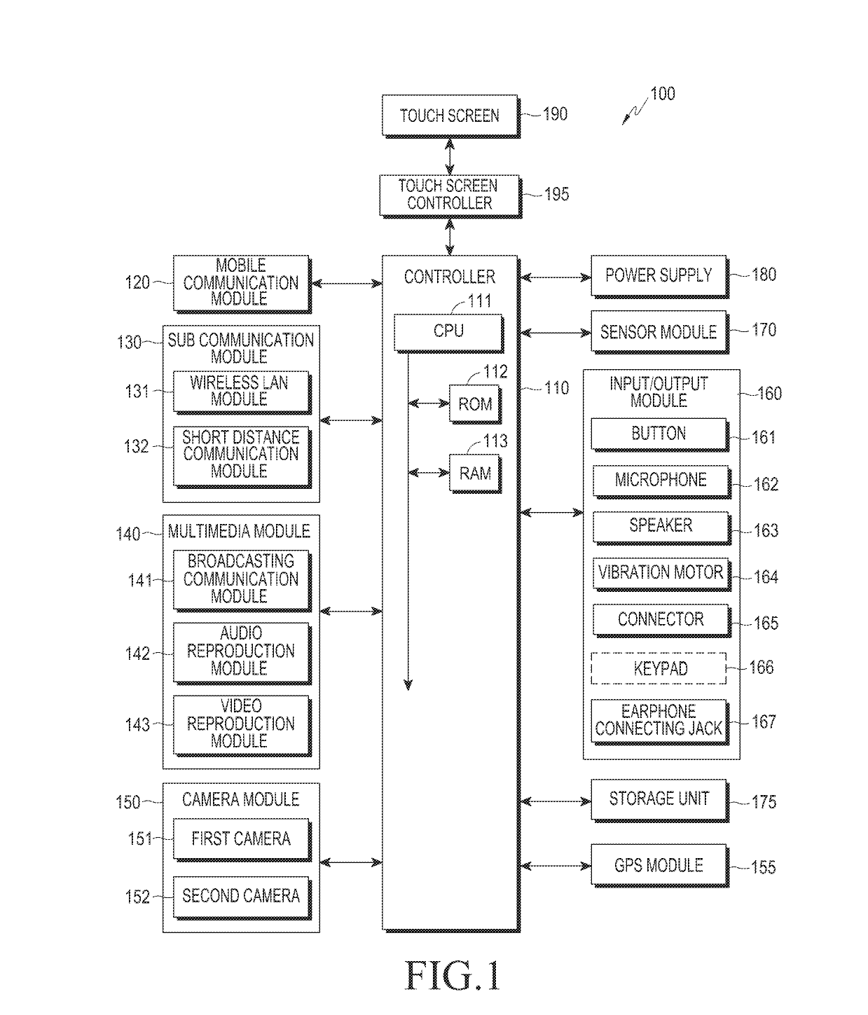

FIG. 1 is a block diagram schematically illustrating a portable device according to an embodiment of the present disclosure.

Referring to FIG. 1, an apparatus (e.g., portable device) 100 may be connected to an external device (not shown) by using an external device connector such as a sub communication module 130, a connector 165, and an earphone connecting jack 167. The “external device” may include various devices attachable to the apparatus 100 through a cable, such as an earphone, an external speaker, a Universal Serial Bus (USB) memory, a charger, a cradle, a docking station, a Digital Multimedia Broadcasting (DMB) antenna, a mobile payment related device, a health management device (blood sugar tester or the like), a game machine, a car navigation device, and the like. The “external device” may include a Bluetooth communication device, a short distance communication device such as a Near Field Communication (NFC) device, a Wi-Fi Direct communication device, and a wireless Access Point (AC) which may be wirelessly connected to the apparatus 100. In addition, the “external device” may include another device, a mobile phone, a smart phone, a tablet Personal Computer (PC), a desktop PC, and a server.

Referring to FIG. 1, the apparatus 100 includes a display unit 190 and a display controller 195. The apparatus 100 may also include a controller 110, a mobile communication module 120, the sub communication module 130, a multimedia module 140, a camera module 150, a Global Positioning System (GPS) module 155, an input/output module 160, a sensor module 170, a storage unit 175, and a power supplier 180. The sub communication module 130 includes at least one of a wireless Local Area Network (LAN) module 131 and a short distance communication module 132, and the multimedia module 140 includes at least one of a broadcasting communication module 141, an audio reproduction module 142, and a video reproduction module 143. The camera module 150 includes at least one of a first camera 151 and a second camera 152. The input/output module 160 includes at least one of a button 161, a microphone 162, a speaker 163, a vibration motor 164, the connector 165, a keypad 166, and the earphone connecting jack 167. Hereinafter descriptions will be made as to a case where the display unit 190 and the display controller 195 are a touch screen and a touch screen controller, respectively, by way of an example.

The controller 110 may include a CPU 111, a Read Only Memory (ROM) 112 storing a control program for controlling the apparatus 100, and a Random Access Memory (RAM) 113 used as a storage area for storing a signal or data input from the outside of the apparatus 100 or for an operation performed in the apparatus 100. The CPU 111 may include a single core, a dual core, a triple core, or a quadruple core. The CPU 111, the ROM 112 and the RAM 113 may be connected with each other through internal buses.

The controller 110 may control the mobile communication module 120, the sub communication module 130, the multimedia module 140, the camera module 150, the GPS module 155, the input/output module 160, the sensor module 170, the storage unit 175, the power supplier 180, the touch screen 190, and the touch screen controller 195.

The mobile communication module 120 enables the apparatus 100 to be connected with an external device through mobile communication by using one antenna or a plurality of antennas (not shown) according to a control of the controller 110. The mobile communication module 120 transmits/receives a wireless signal for a voice call, a video call, a Short Message Service (SMS), or a Multimedia Message Service (MMS) to/from a mobile phone (not shown), a smart phone (not shown), a tablet PC, or another device (not shown) having a phone number input into the apparatus 100.

The sub communication module 130 may include at least one of the wireless LAN module 131 and the short distance communication module 132. For example, the sub communication module 130 may include only the wireless LAN module 131, only the short distance communication module 132, or both the wireless LAN module 131 and the short distance communication module 132.

The wireless LAN module 131 may be connected to the Internet in a place where a wireless Access Point (AP) (not shown) is installed according to a control of the controller 110. The wireless LAN module 131 supports a wireless LAN standard (IEEE802.11x) of the Institute of Electrical and Electronics Engineers (IEEE). The short distance communication module 132 may wirelessly perform short distance communication between the apparatus 100 and an image forming apparatus (not shown) according to a control of the controller 110. A short distance communication scheme may include Bluetooth, Infrared Data Association (IrDA) communication, Wi-Fi-Direct communication, NFC and the like.

The apparatus 100 may include at least one of the mobile communication module 120, the wireless LAN module 131, and the short distance communication module 132. For example, the apparatus 100 may include a combination of the mobile communication module 120, the wireless LAN module 131, and the short distance communication module 132 according to a capability thereof.

The multimedia module 140 may include the broadcasting communication module 141, the audio reproduction module 142, or the video reproduction module 143. The broadcasting communication module 141 may receive a broadcasting signal (for example, a TV broadcasting signal, a radio broadcasting signal, or a data broadcasting signal) and broadcasting supplement information (for example, Electric Program Guide: EPG or Electric Service Guide: ESG) output from a broadcasting station through a broadcasting communication antenna (not shown) according to a control of the controller 110. The audio reproduction module 142 may reproduce a digital audio file (for example, a file having a file extension of mp3, wma, ogg, or way) stored or received according to a control of the controller 110. The video reproduction module 143 may reproduce a digital video file (e.g., a file having a file extension of mpeg, mpg, mp4, avi, mov, or mkv) stored or received according to the control of the control unit 110. The video reproduction module 143 may reproduce a digital audio file.

The multimedia module 140 may include the audio reproduction module 142 and the video reproduction module 143 except for the broadcasting communication module 141. The audio reproduction module 142 or the video reproduction module 143 of the multimedia module 140 may also be included in the controller 110.

The camera module 150 may include at least one of the first camera 151 and the second camera 152, each of which photographs a still image or a video according to a control of the control unit 110. The first camera 151 or the second camera 152 may include an auxiliary light source (for example, a flash (not shown)) providing light required for the photographing. The first camera 151 may be disposed on a front surface of the apparatus 100, and the second camera 152 may be disposed on a back surface of the apparatus 100. Alternatively, the first camera 151 and the second camera 152 may be closely located to each other and photograph a three dimensional still image or a three dimensional video.

The GPS module 155 may receive radio waves from a plurality of GPS satellites (not shown) in Earth's orbit and calculate a position of the apparatus 100 by using Time of Arrival from the GPS satellites to the apparatus 100.

The input/output module 160 may include at least one of a plurality of buttons 161, the microphone 162, the speaker 163, the vibration motor 164, the connector 165, and the keypad 166.

The button 161 may be formed on a front surface, a side surface, or a back surface of a housing of the apparatus 100, and may include at least one of a power/lock button, a volume button, a menu button, a home button, a back button, and a search button.

The microphone 162 receives a voice or a sound to generate an electrical signal according to a control of the controller 110.

The speaker 163 may output sounds corresponding to various signals (for example, a wireless signal, a broadcasting signal, a digital audio file, a digital video file, taking a picture or the like) of the mobile communication module 120, the sub communication module 130, the multimedia module 140, or the camera module 150 to the outside of the apparatus 100 according to a control of the controller 110. The speaker 163 may output a sound (for example, button tone corresponding to a phone call or ringing tone) corresponding to a function performed by the apparatus 100. One or more speakers 163 may be formed on a proper position or positions of the housing of the apparatus 100.

The vibration motor 164 may convert an electronic signal to a mechanical vibration according to a control of the control unit 110. For example, the vibration motor 164 may be operated when the apparatus 100 in a vibration mode receives a voice call from another device (not shown). One or more vibration motors 164 may be formed within the housing of the apparatus 100. The vibration motor 164 may be operated in response to a user's touch action that touches the touch screen 190 and a continuous touch movement on the touch screen 190.

The connector 165 may be used as an interface for connecting the apparatus 100 with an external device (not shown) or a power source (not shown). The apparatus 100 may transmit or receive data stored in the storage unit 175 of the apparatus 100 to or from an external device (not shown) through a wired cable connected to the connector 165 according to a control of the controller 110. The external device may be a docking station, and the data may be an input signal transmitted from an external input device, for example, a mouse, a keyboard or the like. Further, the apparatus 100 may receive power from a power source (not shown) through the wired cable connected to the connector 165 or charge a battery (not shown) by using the power source.

The keypad 166 may receive a key input from the user to control the apparatus 100. The keypad 166 includes a physical keypad (not shown) formed on the apparatus 100 or a virtual keypad (not shown) displayed on the touch screen 190. The physical keypad (not shown) formed on the apparatus 100 may be omitted according to a capability or a structure of the apparatus 100.

An earphone (not shown) may be inserted into the earphone connecting jack 167 to be connected with apparatus 100.

The sensor module 170 includes at least one sensor for detecting a state of the apparatus 100. For example, the sensor module 170 may include a proximity sensor for detecting whether the user approaches the apparatus 100 and a luminance sensor for detecting an amount of ambient light of the apparatus 100. The sensor module 170 may also include a gyro sensor. The gyro sensor may detect an operation of the apparatus 100 (for example, rotation of the apparatus 100, or acceleration or vibration applied to the apparatus 100), may detect a point of the compass using the magnetic field on Earth, or may detect a gravity acting direction. Further, the sensor module 170 may include an altimeter for measuring an atmospheric pressure to detect an altitude. At least one of the sensors may detect the state, generate a signal corresponding to the detection, and transmit the generated signal to the controller 110. At least one of the sensors of the sensor module 170 may be added or omitted according to a capability of the apparatus 100.

The storage unit 175 may store signals or data input/output in response to the operations of the mobile communication module 120, the sub communication module 130, the multimedia module 140, the camera module 150, the GPS module 155, the input/output module 160, the sensor module 170, and the touch screen 190 according to a control of the control unit 110. The storage unit 175 may store a control program and applications for controlling the apparatus 100 or the controller 110.

The term “storage unit” includes the storage unit 175, the ROM 112 and the RAM 113 within the controller 110, or a memory card (not shown) (for example, an SD card or a memory stick) installed in the apparatus 100. The storage unit may include a non-volatile memory, a volatile memory, a Hard Disc Drive (HDD) or a Solid State Drive (SSD).

The power supplier 180 may supply power to one or more batteries (not shown) arranged at the housing of the apparatus 100 according to a control of the controller 110. The one or more batteries (not shown) supply power to the apparatus 100. Further, the power supplier 180 may supply power input from an external power source (not shown) through a wired cable connected to the connector 165 to the apparatus 100. In addition, the power supplier 180 may supply power wirelessly input from the external power source through a wireless charging technology to the apparatus 100.

The touch screen 190 may provide a user interface corresponding to various services (for example, a call, data transmission, broadcasting, and photographing a picture) to the user. The touch screen 190 may transmit an analog signal corresponding to at least one touch input into the user interface to the touch screen controller 195. The touch screen 190 may receive at least one touch through a body of the user (for example, fingers including a thumb) or a touchable input means. Also, the touch screen 190 may receive a continuous motion of one touch among at least one touch. The touch screen 190 may transmit an analogue signal corresponding to the continuous motion of the input touch to the touch screen controller 195.

In the present disclosure, the touch is not limited to a contact between the touch screen 190 and the user's body or a touchable input means and may include a non-contact touch. The detectable interval of the touch screen 190 may be changed according to a capability or a structure of the apparatus 100.

The touch screen 190 may be implemented in, for example, a resistive type, a capacitive type, an infrared type, or an acoustic wave type.

The touch screen controller 195 converts the analog signal received from the touch screen 190 to a digital signal (for example, X and Y coordinates) and transmits the digital signal to the controller 110. The controller 110 may control the touch screen 190 by using the digital signal received from the touch screen controller 195. For example, the controller 110 may cause a shortcut icon (not illustrated) displayed on the touch screen 190 to be selected or may execute the shortcut icon (not illustrated) in response to a touch. Further, the touch screen controller 195 may be included in the controller 110

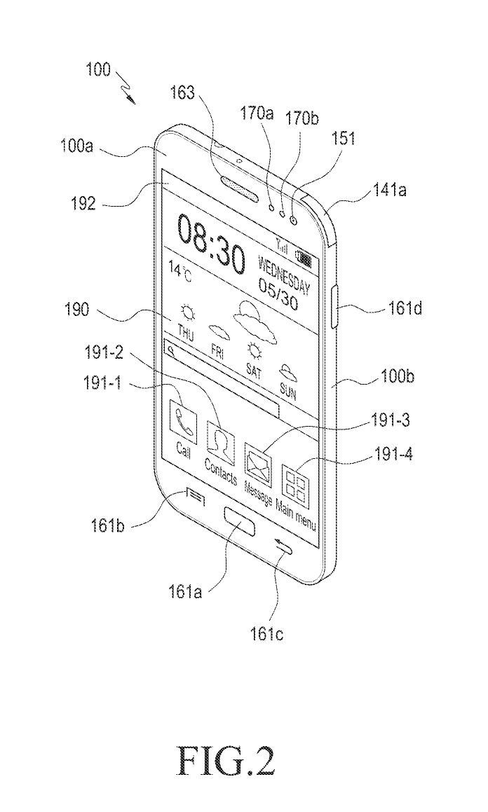

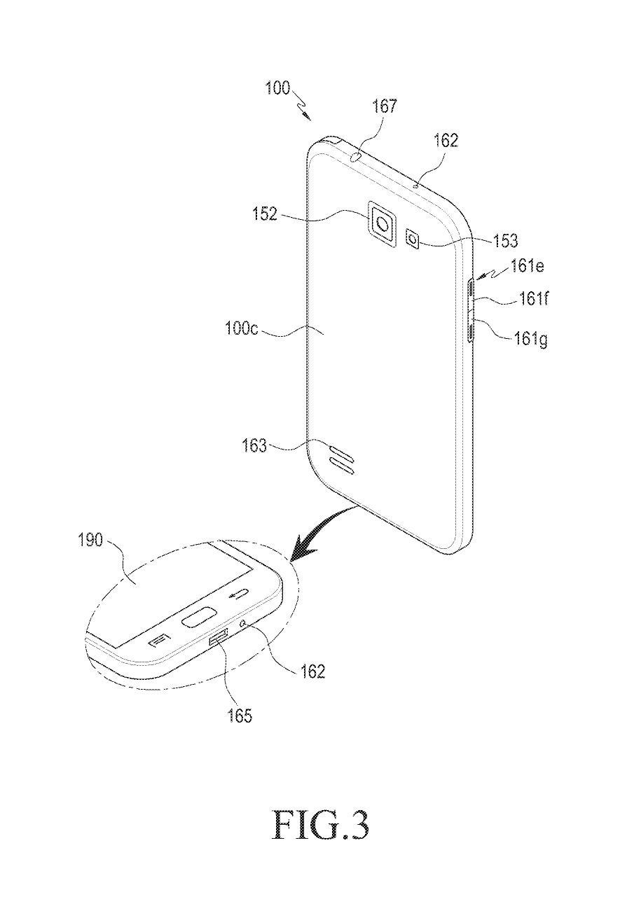

FIG. 2 is a front side perspective view of the portable device according to an embodiment of the present disclosure. FIG. 3 is a rear side perspective view of the portable device according to an embodiment of the present disclosure.

Referring to FIGS. 2 and 3, the touch screen 190 is arranged at a center of a front surface 100a of the apparatus 100. The touch screen 190 is largely formed to occupy most of the front surface 100a of the apparatus 100. FIG. 2 shows an example where a main home screen is displayed on the touch screen 190. The main home screen is a first screen displayed on the touch screen 190 when the apparatus 100 is turned on. When the apparatus 100 includes a plurality of pages of different home screens, the main home screen may be the first home screen among the plurality of pages of home screens. Short-cut icons 191-1, 191-2, and 191-3 for executing frequently used applications, an application switching key 191-4, time, weather and the like may be displayed on the home screen. The application switching key 191-4 displays application icons that indicate applications on the touch screen 190, on a screen. At the upper part of the touch screen 190, a status bar 192 may be formed that indicates the status of the apparatus 100 such as a battery charge status, an intensity of a received signal, and current time.

A home button 161a, a menu button 161b, and a back button 161c may be formed at the lower part of the touch screen 190.

The home button 161a displays the main home screen on the touch screen 190. For example, when the home button 161a is pressed (or touched) while a home screen different from the main home screen is displayed on the touch screen 190, or while a menu screen is displayed on the touch screen 190, the main home screen may be displayed on the touch screen 190. Further, when the home button 161a is pressed (or touched) while an application is being executed on the touch screen 190, the main home screen illustrated in FIG. 2 may be displayed on the touch screen 190. In addition, the home button 161a may be used to display recently used applications or a task manager on the touch screen 190.

The menu button 161b provides a connection menu which can be used on the touch screen 190. The connection menu includes a widget addition menu, a background changing menu, a search menu, an editing menu, an environment setup menu and the like. When an application is executed, a connection menu connected to the application may be provided.

The back button 161c may be used for displaying the screen which was executed just before the currently executed screen or for terminating the most recently used application.

The first camera 151, an illumination sensor 170a, and a proximity sensor 170b may be disposed on edges of the front surface 100a of the apparatus 100. The second camera 152, the flash 153, and the speaker 163 may be disposed on a back surface 100c of the apparatus 100.

A power/reset button 161d, a volume control button 161e (including volume up button 161f and volume down button 161g), a terrestrial DMB antenna 141a that receives broadcasting, or one or more microphones 162 may be arranged on a side surface 100b of the apparatus 100. The DMB antenna 141a may be fixed to the apparatus 100 or may be formed to be detachable from the apparatus 100.

The connector 165 is formed on a lower side surface of the apparatus 100. A plurality of electrodes are formed on the connector 165, and the connector 165 may be connected to an external device through a wire. The earphone connecting jack 167 may be formed on an upper side surface of the apparatus 100. An earphone may be inserted into the earphone connecting jack 167.

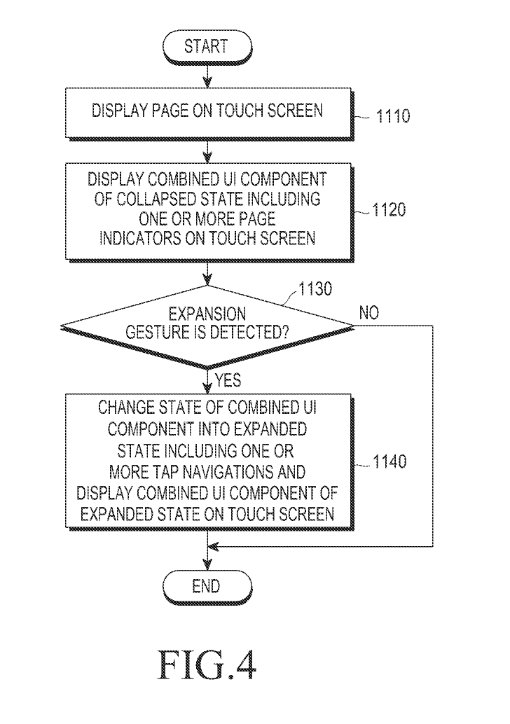

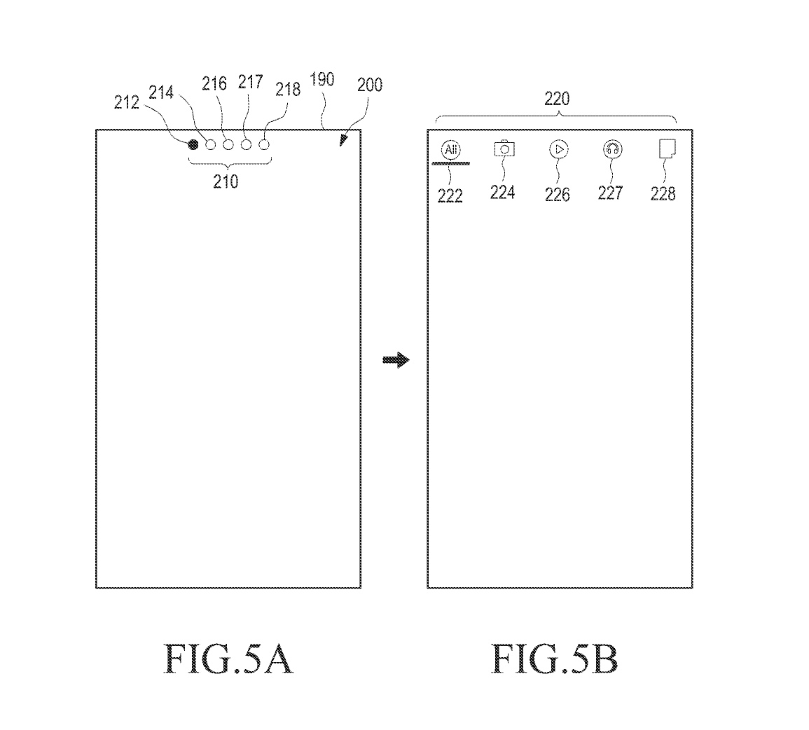

FIG. 4 is a flowchart illustrating a method of controlling a portable device that provides a combined User Interface (UI) component according to an embodiment of the present disclosure. FIGS. 5A and 5B illustrate screens showing combined UI components according to an embodiment of the present disclosure.

Referring to FIG. 4, a page is displayed on a touch screen in operation 1110. The controller 110 of the portable device 100 may display the page on the touch screen 190. The page may correspond to one or more pages. The controller 110 may display one of the one or more pages on most of an entire area of the touch screen 190.

For example, referring to FIG. 5A, the controller 110 may display a page 200 on the touch screen 190. The controller 110 may display the one page 200 of the one or more pages on most of an entire area of the touch screen 190.

A combined UI component of a collapsed state including one or more page indicators is displayed on the touch screen in operation 1120. The controller 110 may display the combined UI component of the collapsed state including the one or more page indicators on the touch screen.

The one or more page indicators may be indicators corresponding to the one or more pages. For example, a first page indicator of the one or more page indicators may correspond to a first page of the one or more pages. Similarly, second to fifth page indicators may correspond to second to fifth pages, respectively.

When the one or more page indicators are selected, the controller 110 may display the one or more pages corresponding to the one or more page indicators on the touch screen. For example, when the first page indicator is selected, the controller 110 may display the first page corresponding to the first page indicator on the touch screen. When the second to fifth page indicators are selected, the controller 110 may display the second to fifth pages corresponding to the second to fifth page indicators, respectively, on the touch screen.

For example, referring to FIG. 5A, the controller 110 may display one or more page indicators 212 to 218 on the touch screen 190. The one or more page indicators may be a first page indicator 212, a second page indicator 214, a third page indicator 216, a fourth page indicator 217, and a fifth page indicator 218. The first to fifth page indicators 212 to 218 may correspond to first to fifth pages, respectively. For example, as illustrated in FIG. 5A, when the first page indicator 212 is selected, the controller 110 may display the first page 200 corresponding to the first page indicator 212 on the touch screen 190. Further, when the first page indicator 212 is selected, the controller 110 may display the first page indicator 212 to be deeply shaded as illustrated in FIG. 5A.

In addition, the controller 110 may display a combined UI component of a collapsed state including the one or more page indicators on the touch screen. The collapsed state may be a state of the UI component more greatly collapsed than an expanded state described below. The combined UI component may be a UI component in which the collapsed state and the expanded state are combined. For example, the collapsed state may be a state which is smaller than the expanded state, does not include additional information, or has the pages forwardly arranged.

For example, as illustrated in FIG. 5A, the controller 110 may display a combined UI component 210 of the collapsed state including the one or more page indicators 212 to 218 on the touch screen 190. The combined UI component 210 of the collapsed state may be smaller than a combined UI component of the expanded state described below or may not include additional information.

An expansion gesture of changing the combined UI component of the collapsed state into the combined UI component of the expanded state is detected in operation 1130. The controller 110 may detect the expansion gesture of changing the combined UI component of the collapsed state into the combined UI component of the expanded state. For example, the expansion gesture may be a touch or a hovering with respect to the page or the one or more page indicators. The touch may also be at least one tap, drag, or swipe performed on the touch screen. However, it may be easily understood by those skilled in the art that the touch may be a touch different from the above listed examples.

For example, as illustrated in FIG. 5A, the expansion gesture may be a swipe with respect to the one or more page indicators 212 to 218. Accordingly, the controller 110 may detect the expansion gesture, such as the swipe, with respect to the one or more page indicators 212 to 218.

When the expansion gesture is detected, a state of the combined UI component is changed into the expanded state including one or more tab navigations and the combined UI component of the expanded state is displayed on the touch screen in operation 1140. In contrast, when the expansion gesture is not detected, the process ends. When the expansion gesture is detected, the controller 110 may change the state of the combined UI component into the expanded state including one or more tab navigations and display the combined UI component of the expanded state on the touch screen.

The one or more tab navigations may be navigations corresponding to the page according to the type of content included in the page. For example, an all tab navigation of the one or more tab navigations may correspond to a first page including all content. A photo tab navigation of the one or more tab navigations may correspond to a second page including photo content. A video tab navigation of the one or more tab navigations may correspond to a third page including a video content. A music tab navigation of the one or more tab navigations may correspond to a fourth page including music content. A doc tab navigation of the one or more tab navigations may correspond to a fifth page including document content.

When the one or more tab navigations are selected, the controller 110 may display the one or more pages corresponding to the one or more tab navigations on the touch screen. For example, when the all tab navigation is selected, the controller 110 may display the first page including all content corresponding to the all tab navigation on the touch screen. Similarly, when the photo tab navigation, the video tab navigation, the music tab navigation, and the doc tab navigation are selected, the controller 110 may display the second page including the photo content, the third page including the video content, the fourth page including the music content, and the fifth page including the document content corresponding to the photo tab navigation, the video tab navigation, the music tab navigation, and the doc tab navigation, respectively, on the touch screen.

For example, referring to FIG. 5B, the controller 110 may display one or more tab navigations 222 to 228 on the touch screen 190. The one or more tab navigations may be an all tab navigation 222, a photo tab navigation 224, a video tab navigation 226, a music tab navigation 227, and a doc tab navigation 228.

Accordingly, when the expansion gesture is detected, the controller 110 may change a state of the combined UI component into the expanded state including one or more tab navigations and display the combined UI component of the expanded state on the touch screen. For example, as illustrated in FIG. 5A, the expansion gesture may be a swipe with respect to the one or more page indicators 212 to 218. Accordingly, when the expansion gesture (such as the swipe) with respect to the one or more page indicators 212 to 218 is detected, the controller 110 may change the state of the combined UI component 220 into the expanded state including the one or more tab navigations 222 to 228 and display the combined UI component of the expanded state on the touch screen as illustrated in FIG. 5B.

The expanded state may be a state which is larger than the collapsed state, includes additional information, or has the pages temporarily rearranged. The additional information may include one or more of an icon representing a type of content included in the page, a text indicating a type of content, a number of content, a number of notifications newly added to the page, a notification of a content newly added to the page, a number of content newly added to the page, and a notification of a content newly edited in the page.

For example, as illustrated in FIG. 5B, the controller 110 may change the combined UI component 210 of the collapsed state of FIG. 5A into the combined UI component 220 of the expanded state which is larger than the combined UI component 210 of the collapsed state and display the combined UI component 220 of the expanded state. In FIG. 5B, the one or more tab navigations 222 to 228 are included, and the combined UI component 210 of the collapsed state of FIG. 5A may be changed into the combined UI component 220 of the expanded state which is larger than the combined UI component 210 of the collapsed state and the combined UI component 220 of the expanded state may be displayed. Further, the controller 110 may change the state of the combined UI component 220 into the expanded state including the additional information 222 to 228, such as icons representing types of content included in the page, and may display the combined UI component 220 of the expanded state.

Accordingly, according to an embodiment of the present disclosure, a combined UI component is provided in which the collapsed state and the expanded state are combined. Further, according to an embodiment of the present disclosure, the combined UI component of the collapsed state may be changed into the combined UI component of the expanded state the combined UI component of the expanded state may be displayed when the expansion gesture is detected. Accordingly, there is an advantage in which the user can use the combined UI component of the expanded state by changing the combined UI component through the expansion gesture. The user can use the combined UI component which has a larger size, includes additional information, or has pages temporarily rearranged through the expanded state.

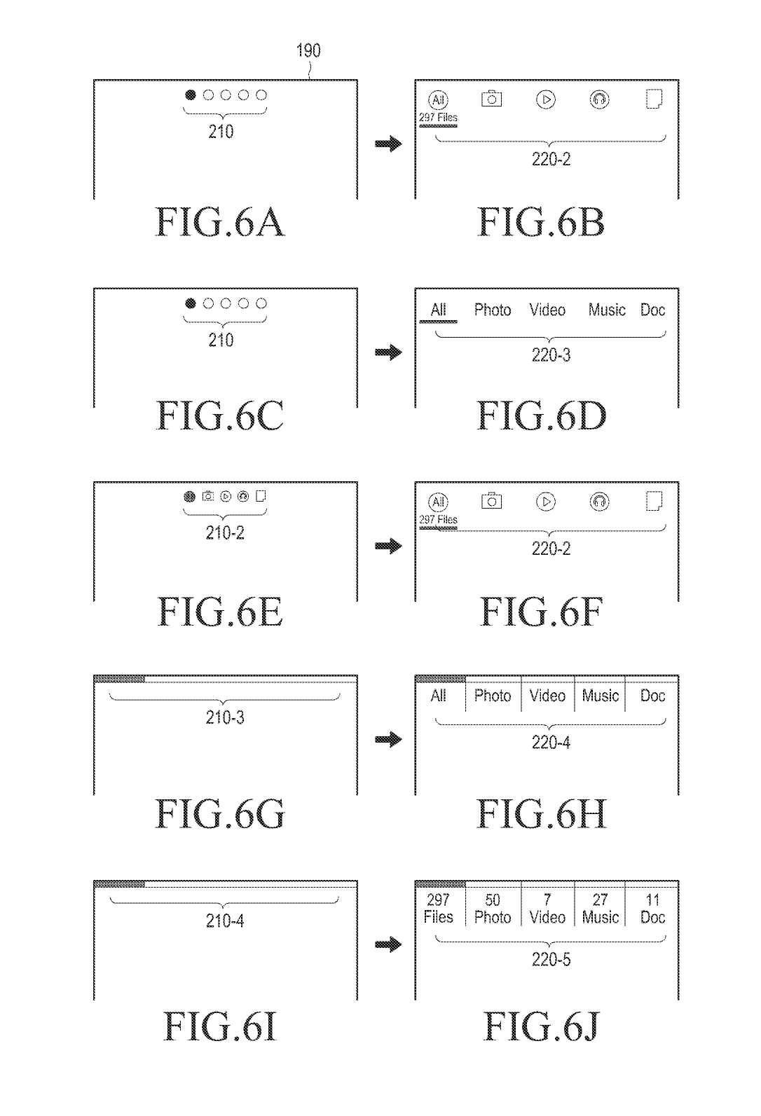

FIGS. 6A to 6J illustrate screens showing combined UI components according to a first example of the present disclosure.

Referring to FIGS. 6A to 6J, the controller 110 may change the combined UI component 210 of the collapsed state of FIG. 6A into a combined UI component 220-2 of the expanded state, which is larger than the combined UI component 210 of the collapsed state and which includes icons representing types of content included in the page and the same number of additional information as the number of content, and may display the combined UI component 220-2 of the expanded state.

In another example, as illustrated in FIG. 6D, the controller 110 may change the combined UI component 210 of the collapsed state of FIG. 6C into a combined UI component 220-3 of the expanded state, which is larger than the combined UI component 210 of the collapsed state and includes text indicating types of content included in the page, and may display the combined UI component 220-3 of the expanded state.

In another example, as illustrated in FIG. 6F, the controller 110 may change a combined UI component 210-2 of the collapsed state of FIG. 6E including icons representing types of content included in the page into the combined UI component 220-2 of the expanded state, which is larger than the combined UI component 210-2 of the collapsed state and which includes the same number of additional information as the number of content, and may display the combined UI component 220-2 of the expanded state.

In another example, as illustrated in FIG. 6H, the controller 110 may change a bar-shaped combined UI component 210-3 of the collapsed state of FIG. 6G into a combined UI component 220-4 of the expanded state, which includes text indicating types of content included in the page, and may display the combined UI component 220-4 of the expanded state.

In another example, as illustrated in FIG. 6J, the controller 110 may change a bar-shaped combined UI component 210-4 of the collapsed state of FIG. 6I into a combined UI component 220-5 of the expanded state, which includes the number of content included in the page, and may display the combined UI component 220-5 of the expanded state.

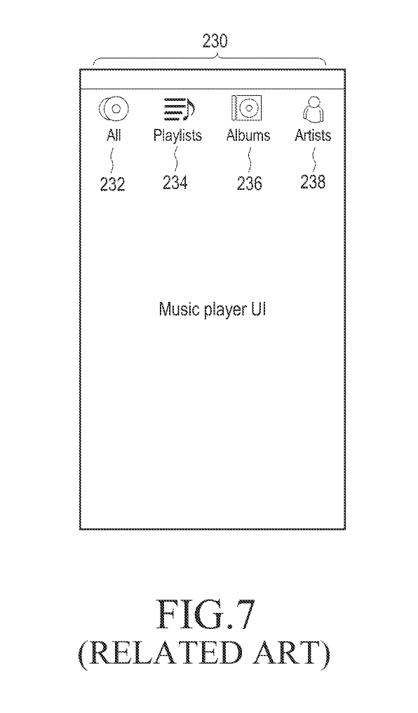

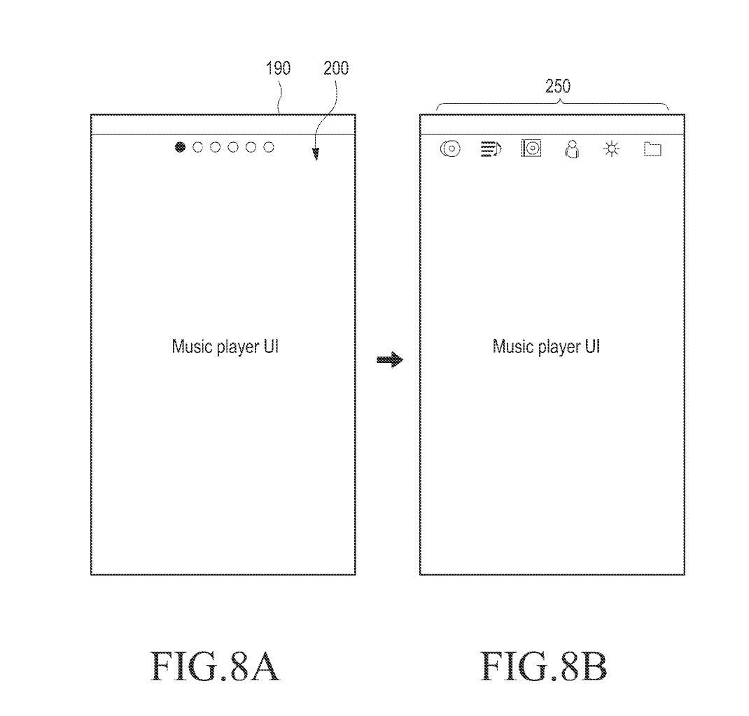

FIG. 7 illustrates a screen according to the related art. FIGS. 8A and 8B illustrate screens showing combined UI components according to a second embodiment of the present disclosure.

Referring to FIG. 7, according to the related art, a tab navigation 230 is displayed. For example, when a music player application is executed, the tab navigation 230 may include an all music tab 232, a play list tab 234, an album tab 236, and an artist tab 238. Accordingly, the comparative example of the related art of FIG. 7 has a problem in which the tab navigation 230 occupies a considerable portion of the screen and thus the remaining parts of the screen cannot be used.

However, referring to FIGS. 8A and 8B corresponding to the second example of the present disclosure, a combined UI component of the collapsed state may be first displayed as illustrated in FIG. 8A. Accordingly, there is an advantage in which the user can use a wider area in the collapsed state in comparison with FIG. 7. When the expansion gesture is detected, the controller 110 may change a state of the combined UI component into the expanded state and display the combined UI component 250 of the expanded state as illustrated in FIG. 8B. Then, an advantage is created in which the user can recognize the combined UI component of which the state is changed into the expanded state having a large size and including additional information.

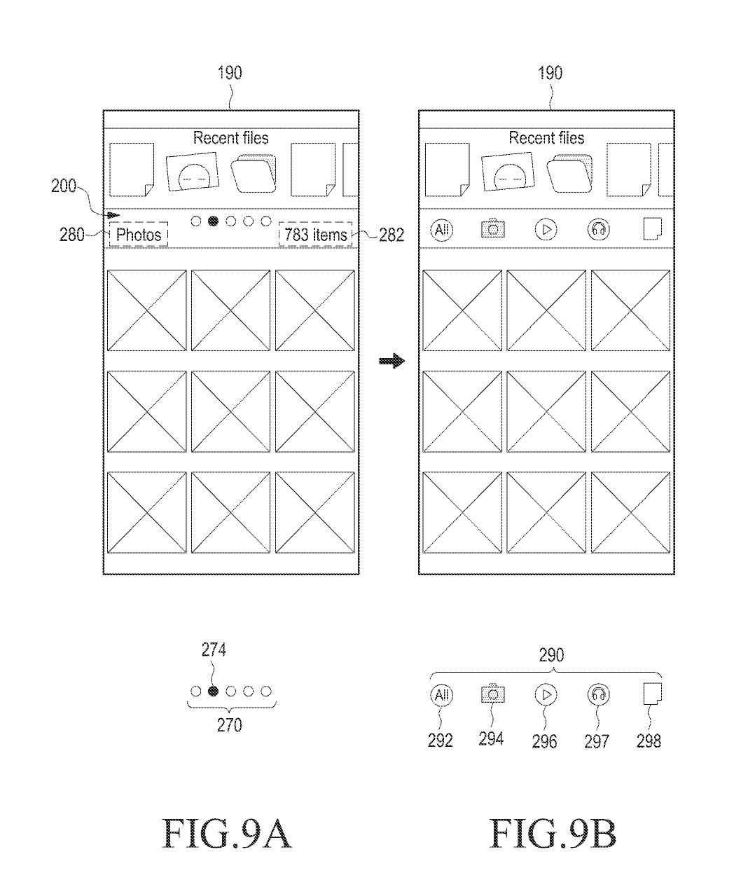

FIGS. 9A and 9B illustrate screens showing combined UI components according to a third example of the present disclosure.

Referring to FIGS. 9A and 9B, one or more page indicators 270 in the collapsed state may be displayed in FIG. 9A. A second page 200 corresponding to a second page indicator 274 may also be displayed. In addition, text (photo) 280 indicating a type of content included in the second page 200 and a number of content (783 items) 282 may be displayed. When the expansion gesture is detected, the controller 110 may display the combined UI component of the expanded state as illustrated in FIG. 9B. The controller 110 may change the combined UI component 270 of the collapsed state of FIG. 9A into a combined UI component 290 of the expanded state, which is larger than the UI component 270 of the collapsed state and includes additional information 292 to 298 such as icons representing types of content included in the page, and display the UI component 290 of the expanded state.

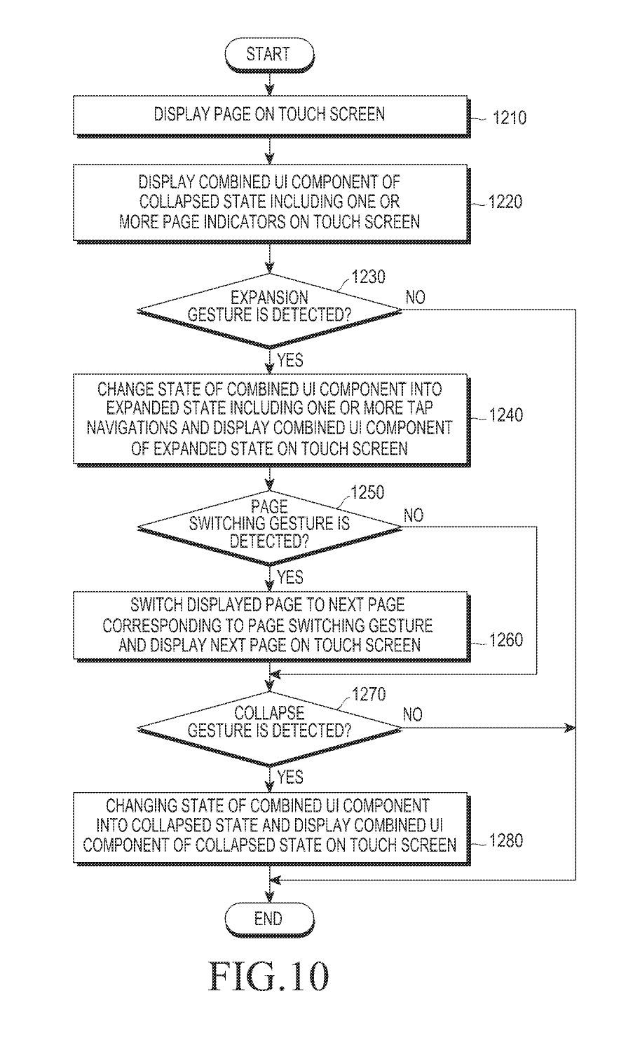

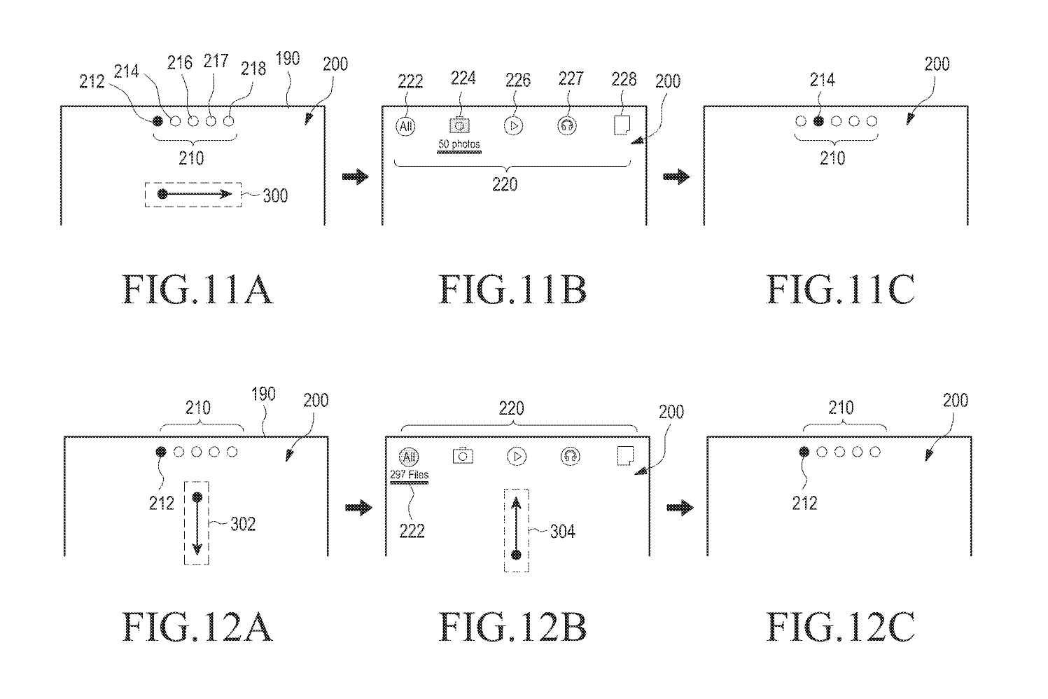

FIG. 10 is a flowchart illustrating a method of controlling the portable device that provides a combined UI component according to another embodiment of the present disclosure. FIGS. 11A to 11C illustrate screens showing combined UI components according to another embodiment of the present disclosure.

Referring to FIG. 10 and FIGS. 11A to 11C, a page is displayed on the touch screen in operation 1210. The controller 110 of the portable device 100 may display the page on the touch screen 190. The page may correspond to one or more pages. The controller 110 may display one of the one or more pages on most of an entire area of the touch screen 190.

For example, referring to FIG. 11A, the controller 110 may display the page 200 on the touch screen 190. The controller 110 may display the one page 200 of the one or more pages on most of an entire area of the touch screen 190.

A combined UI component of the collapsed state including one or more page indicators is displayed on the touch screen in operation 1220. The controller 110 may display the combined UI component of the collapsed state including the one or more page indicators on the touch screen.

The one or more page indicators may be indicators corresponding to the one or more pages. For example, a first page indicator of the one or more page indicators may correspond to a first page of the one or more pages. Similarly, second to fifth page indicators may correspond to second to fifth pages, respectively.

When the one or more page indicators are selected, the controller 110 may display the one or more pages corresponding to the one or more page indicators on the touch screen. For example, when the first page indicator is selected, the controller 110 may display the first page corresponding to the first page indicator on the touch screen. When the second to fifth page indicators are selected, the controller 110 may display the second to fifth pages corresponding to the second to fifth page indicators, respectively, on the touch screen.

For example, referring to FIG. 11A, the controller 110 may display one or more page indicators 212 to 218 on the touch screen 190. The one or more page indicators may be a first page indicator 212, a second page indicator 214, a third page indicator 216, a fourth page indicator 217, and a fifth page indicator 218. The first to fifth page indicators 212 to 218 may correspond to first to fifth pages, respectively. When the first page indicator 212 is selected, the controller 110 may display the first page 200 corresponding to the first page indicator 212 on the touch screen 190. When the first page indicator 212 is selected, the controller 110 may display the first page indicator 212 to be deeply shaded as illustrated in FIG. 11A.

In addition, the controller 110 may display the combined UI component of the collapsed state including the one or more page indicators on the touch screen. The collapsed state may be a state of the UI component, which is more greatly collapsed than an expanded state described below. The combined UI component may be a UI component in which the collapsed state and the expanded state are combined. For example, the collapsed state may be a state which is smaller than the expanded state, does not include additional information, or has the pages forwardly arranged.

As illustrated in FIG. 11A, the controller 110 may display a combined UI component 210 of the collapsed state including the one or more page indicators 212 to 218 on the touch screen 190. The combined UI component 210 of the collapsed state may be smaller than a combined UI component of the expanded state or may not include additional information.

An expansion gesture of changing the combined UI component of the collapsed state into the combined UI component of the expanded state is detected in operation 1230. The controller 110 may detect the expansion gesture of changing the combined UI component of the collapsed state into the combined UI component of the expanded state. For example, the expansion gesture may be a touch or a hovering with respect to the page or the one or more page indicators. For example, the touch may be at least one of tap, drag, or swipe performed on the touch screen. However, it may be easily understood by those skilled in the art that the touch may be a touch different from the above listed examples.

For example, as illustrated in FIG. 11A, the expansion gesture may be a drag or swipe 300 with respect to the page 200. Accordingly, the controller 110 may detect the expansion gesture, such as the drag or the swipe 300, with respect to the page 200.

When the expansion gesture is detected, a state of the combined UI component is changed into the expanded state including one or more tab navigations and the combined UI component of the expanded state is displayed on the touch screen in operation 1240. In contrast, when the expansion gesture is not detected, the process ends. When the expansion gesture is detected, the controller 110 may change the state of the combined UI component into the expanded state including one or more tab navigations and display the combined UI component of the expanded state on the touch screen.

The one or more tab navigations may be navigations corresponding to the page according to types of content included in the page. For example, an all tab navigation of the one or more tab navigations may correspond to a first page including all content. A photo tab navigation of the one or more tab navigations may correspond to a second page including photo content. A video tab navigation of the one or more tab navigations may correspond to a third page including video content. A music tab navigation of the one or more tab navigations may correspond to a fourth page including music content. A doc tab navigation of the one or more tab navigations may correspond to a fifth page including document content.

When the one or more tab navigations are selected, the controller 110 may display the one or more pages corresponding to the one or more tab navigations on the touch screen. For example, when the all tab navigation is selected, the controller 110 may display the first page including all content corresponding to the all tab navigation on the touch screen. Similarly, when the photo tab navigation, the video tab navigation, the music tab navigation, and the doc tab navigation are selected, the controller 110 may display the second page including the photo content, the third page including the video content, the fourth page including the music content, and the fifth page including the document content corresponding to the photo tab navigation, the video tab navigation, the music tab navigation, and the doc tab navigation, respectively, on the touch screen.

Referring to FIG. 11B, the controller 110 may display one or more tab navigations 222 to 228 on the touch screen 190. The one or more tab navigations may be an all tab navigation 222, a photo tab navigation 224, a video tab navigation 226, a music tab navigation 227, and a doc tab navigation 228.

Accordingly, when the expansion gesture is detected, the controller 110 may change a state of the combined UI component into the expanded state including one or more tab navigations and display the combined UI component of the expanded state on the touch screen. For example, as illustrated in FIG. 11A, the expansion gesture may be a drag or swipe 300 with respect to the page 200. Accordingly, when the expansion gesture, such as the drag or the swipe 300, with respect to the page 200 is detected, the controller 110 may change a state of the combined UI component 220 into the expanded state including the one or more tab navigations 222 to 228 and display the combined UI component of the expanded state on the touch screen as illustrated in FIG. 11B.

The expanded state may be a state, which is larger than the collapsed state, includes additional information, or has the pages temporarily rearranged. The additional information may include one or more of an icon representing a type of content included in the page, a text indicating a type of content, a number of content, a number of notifications newly added to the page, a notification of a content newly added to the page, a number of content newly added to the page, and a notification of a content newly edited in the page.

For example, as illustrated in FIG. 11B, the controller 110 may change the combined UI component 210 of the collapsed state of FIG. 11A into the combined UI component 220 of the expanded state which is larger than the combined UI component 210 of the collapsed state and display the combined UI component 220 of the expanded state. In FIG. 11B, the one or more tab navigations 222 to 228 are included, and the combined UI component 210 of the collapsed state of FIG. 11A may be changed into the combined UI component 220 of the expanded state which is larger than the combined UI component 210 of the collapsed state and the combined UI component 220 of the expanded state may be displayed. The controller 110 may change a state of the combined UI component 220 into the expanded state including the additional information 222 to 228, such as icons representing types of content included in the page and display the combined UI component 220 of the expanded state.

A page switching gesture of switching the page is detected in operation 1250. The controller 110 may detect the page switching gesture of switching the page. For example, the page switching gesture may be a touch or a hovering with respect to the page, the one or more page indicators, or the one or more tab navigations.

When the page switching gesture is detected, the displayed page is switched to a next page corresponding to the page switching gesture and the next page is displayed on the touch screen in operation 1260. In contrast, when the page switching gesture is not detected, the displayed page is not switched to the next page corresponding to the page switching gesture. When the page switching gesture is detected, the controller 110 may switch the displayed page to the next page corresponding to the page switching gesture and display the next page on the touch screen.

For example, as illustrated in FIG. 11B, the page switching gesture may be the touch with respect to the one or more page indicators. For example, when the photo tab navigation 224 is selected, the controller 110 may switch the first page corresponding to the displayed page to the second page including the photo content corresponding to the photo tab navigation 224 and display the second page on the touch screen.

A collapse gesture of changing the combined UI component of the expanded state into the combined UI component of the collapsed state is detected in operation 1270. The controller 110 may detect the collapse gesture of changing the combined UI component of the expanded state into the combined UI component of the collapsed state. For example, the collapse gesture may correspond to a touch or a hovering with respect to the page or one or more tab navigations, no input for a preset time or longer, or an end of loading of content included in the page.

When the collapse gesture is detected, a state of the combined UI component is changed into the collapsed state and the combined UI component of the collapsed state is displayed on the touch screen in operation 1280. In contrast, when the collapse gesture is not detected, the process ends. When the collapse gesture is detected, the controller may change the state of the combined UI component into the collapsed state and display the combined UI component of the collapsed state on the touch screen.

For example, the collapse gesture may be a lack of input for a preset time or longer. For example, when the preset time is two seconds, and there is no input for two seconds or longer, the controller 110 may change the state of the combined UI component into the collapsed state and may display the combined UI component of the collapsed state on the touch screen. As illustrated in FIG. 11C, the controller 110 may change the state of the combined UI component into the collapsed state 210 including the one or more page indicators 212 to 218 and may display the combined UI component of the collapsed state on the touch screen 190.

According to another embodiment of the present disclosure, the combined UI component is changed from the expanded state to the collapsed state and the combined UI component of the collapsed state is displayed when the collapse gesture is detected. Accordingly, the user can freely change and use the combined UI component through the collapse gesture or the expansion gesture.

FIGS. 12A to 12C illustrate screens showing combined UI components according to a fourth example of the present disclosure.

Referring to FIG. 12A, the expansion gesture may be a drag or swipe 302 in a downward direction with respect to the page 200. Accordingly, when the drag or swipe 302 in the downward direction with respect to the page 200 is detected, the controller 110 may change a state of the combined UI component into the expanded state 220 and may display the combined UI component of the expanded state as illustrated in FIG. 12B. The collapse gesture may be a drag or swipe 304 in an upward direction with respect to the page 200. Accordingly, when the drag or swipe 302 in the upward direction with respect to the page 200 is detected, the controller 110 may change a state of the combined UI component into the collapsed state 210 and may display the combined UI component of the collapsed state as illustrated in FIG. 12C.

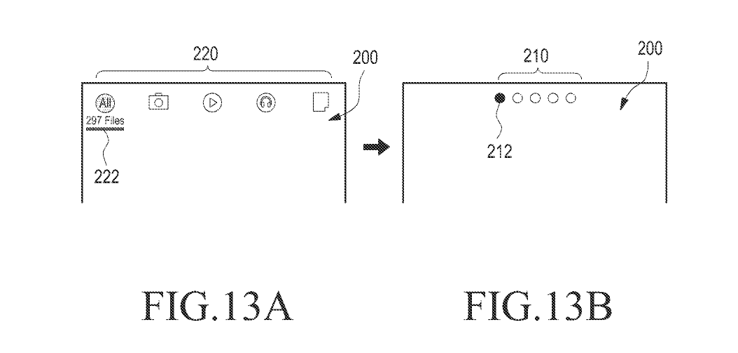

FIGS. 13A and 13B illustrate screens showing combined UI components according to a fifth example of the present disclosure.

Referring to FIGS. 13A and 13B, the combined UI component of the expanded state 220 is displayed in FIG. 13A. The collapse gesture may be a completion of loading content included in the page. As illustrated in FIG. 13A, when all content included in the page is loaded, the controller 110 may change a state of the combined UI component into the collapsed state 210 and display the combined UI component of the collapsed state as illustrated in FIG. 13B.

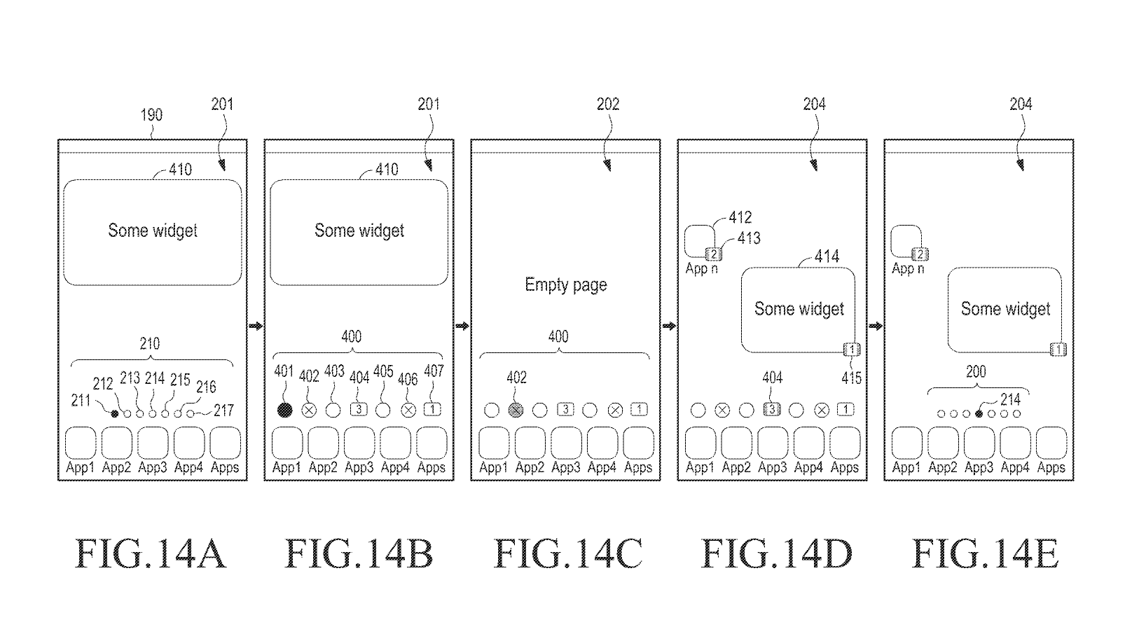

FIGS. 14A to 14E illustrate screens showing combined UI components according to a sixth example of the present disclosure.

Referring to FIGS. 14A to 14E, a page 201 may be displayed on a home screen as in FIG. 14A. In addition, a widget 410, or content such as a short-cut 412 may be displayed. The controller 110 may display the combined UI component 210 of the collapsed state including first to seventh page indicators 211 to 217 corresponding to first to seventh pages, respectively, on the touch screen 190. When the expansion gesture is detected, the controller 110 may change a state of the combined UI component into an expanded state 400 including one or more tab navigations 401 to 407 and display the combined UI component of the expanded state as illustrated in FIG. 14B. Additional information, such as the number of notifications newly added to the page, may be included in the expanded state 400. Accordingly, the controller 110 may display a number corresponding to three notifications newly added to the fourth page and a number corresponding to one notification newly added to the seventh page as illustrated in FIG. 14B. The controller 110 may also display X marks and indicating that the corresponding pages are empty. For example, when the page switching gesture, such as the touch, is detected on the second tab navigation 402 corresponding to the second page, the controller 110 may switch a page to the second page 202 and display the second page 202 as illustrated in FIG. 14C.

As recognized by the X mark 402 indicating that the page is empty, it may be noted that the second page 202 is empty. For example, when the page switching gesture, such as the touch, is detected on the fourth tab navigation 404 corresponding to the fourth page, the controller 110 may switch a page to the fourth page 204 and display the fourth page 204 as illustrated in FIG. 14D. As recognized by the number of newly added notifications 404 corresponding, the fourth page 204 has two notifications 413 newly added to the short-cut 412 and one notification 415 newly added to the widget 414. When the collapse gesture is detected, the controller 110 may change a state of the combined UI component into the collapsed state 200 and display the combined UI component of the collapsed state as illustrated in FIG. 14E.

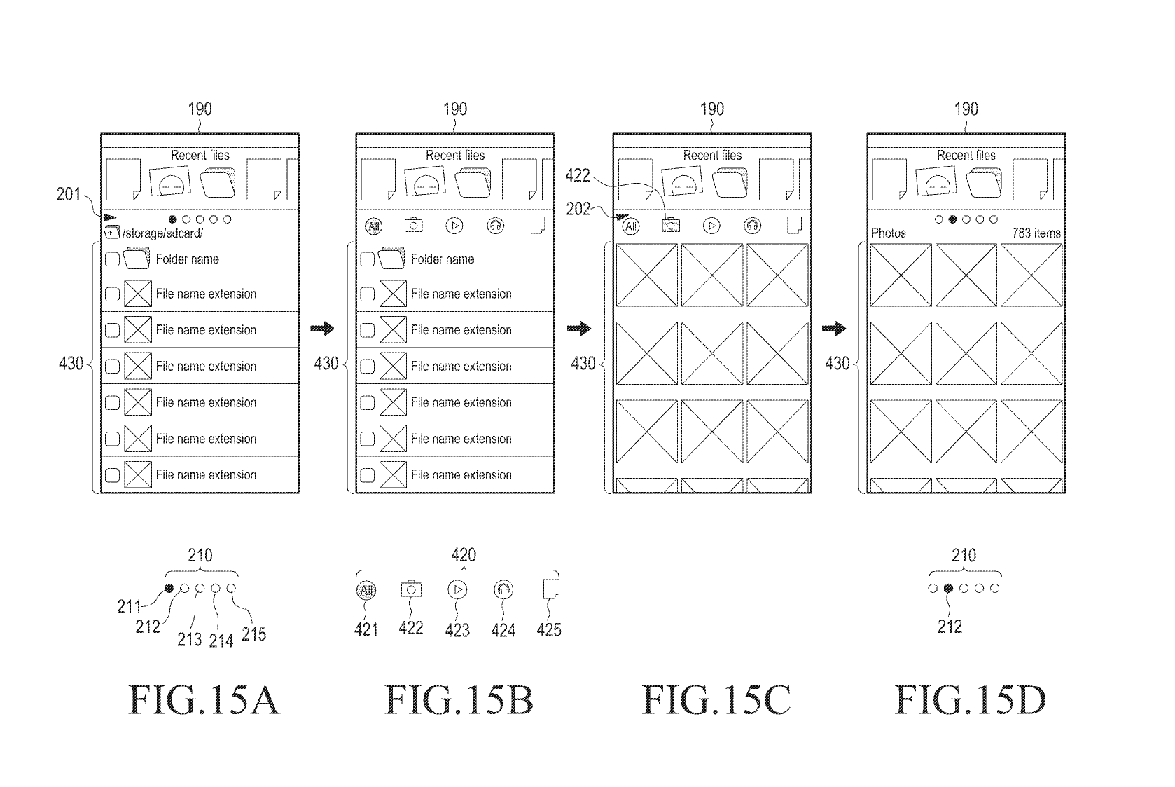

FIGS. 15A to 15D illustrate screens showing combined UI components according to a seventh example of the present disclosure.

Referring to FIG. 15A, the page 201 may be displayed on a file called My File. In addition, content, such as files 430, may be displayed on the My File. The controller 110 may display the combined UI component 210 of the collapsed state including first to fifth page indicators 211 to 215 corresponding to first to fifth pages, respectively, on the touch screen 190. When the expansion gesture is detected, the controller 110 may change a state of the combined UI component into an expanded state 420 including one or more tab navigations 421 to 425 and display the combined UI component of the expanded state as illustrated in FIG. 15B. Additional information, such as icons 421 to 425 representing types of content included in the page, may be included in the expanded state 420. For example, when the page switching gesture, such as the touch, is detected on the photo tab navigation 422 corresponding to the second page, the controller 110 may switch a page to the second page 202 corresponding to the photo page and may display the second page 202 as illustrated in FIG. 15C. The second page 202 includes photo content 430. When the collapse gesture is detected, the controller 110 may change a state of the combined UI component into the collapsed state 210 and may display the combined UI component of the collapsed state as illustrated in FIG. 15D. At this time, the second page indicator 212 corresponding to the second page may be deeply shaded.

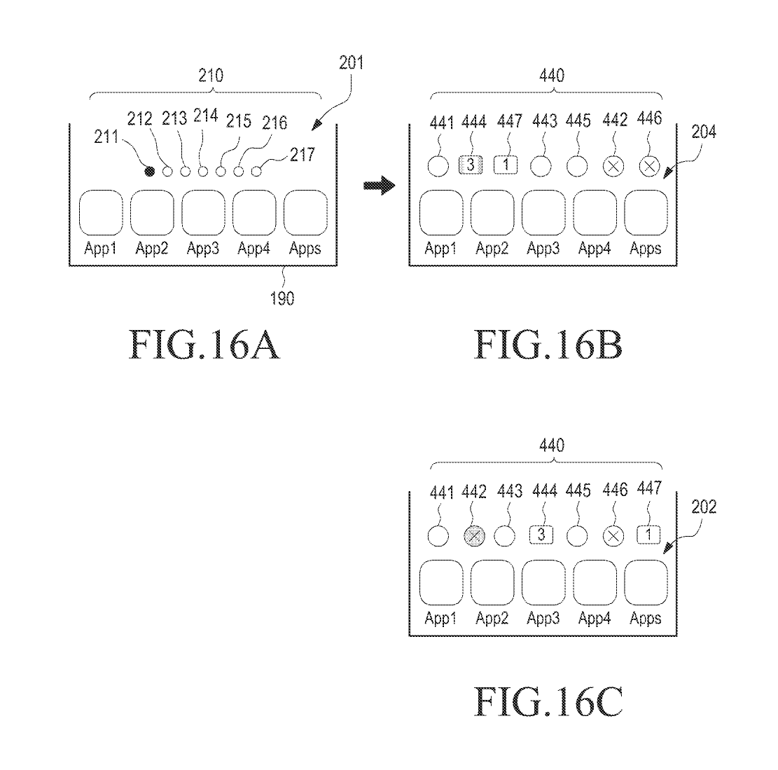

FIGS. 16A to 16C illustrate screens showing combined UI components according to an eighth example of the present disclosure.

Referring to FIGS. 16A to 16C, the controller 110 may display the first page 201 on the touch screen 190. The controller 110 may display the combined UI component 210 of the collapsed state including the one or more page indicators 211 to 217 on the touch screen. At this time, the first page indicator 211 corresponding to the first page may be deeply shaded. When the expansion gesture is detected, the controller 110 may change a state of the combined UI component 440 into the expanded state including one or more tab navigations 441 to 447 and may display the combined UI component of the expanded state on the touch screen. In the expanded state, orders of the pages may be temporarily rearranged. The rearrangement may be temporarily performed according to the priority of the pages. For example, a page having a larger number of newly added notifications may have a higher priority.

FIG. 16C illustrates a screen displaying the combined UI component 440 of the expanded state including the one or more tab navigations 441 to 447 according to the original page order. Referring to FIG. 16C, the first to seventh tab navigations 441 to 447 corresponding to the first to seventh pages may be displayed. In contrast, FIG. 16B illustrates a screen in which the pages are temporarily rearranged based on the priority according to the eighth example of the present disclosure. For example, according to the priority in which the page having the larger number of newly added notifications has the higher priority, in FIG. 16B the fourth page has the largest number of newly added notifications (three) and the seventh page has the next largest number of newly added notifications (one). Accordingly, as illustrated in FIG. 16B, the controller 110 may temporarily display the fourth tab navigation 444 corresponding to the fourth page in the second position and the seventh tab navigation 447 corresponding to the seventh page in the third position according to the priority. The controller 110 may display the third tab navigation 443 corresponding to the third page and the fifth tab navigation 445 corresponding to the fifth page which have content, and display the second tab navigation 442 corresponding to the second page and the sixth tab navigation 446 corresponding to the sixth page which have no content. Accordingly, when the page switching gesture is detected, the controller 110 may first display the fourth page 204 as illustrated in FIG. 16B. However, the rearrangement may be temporary. Accordingly, for example, when the collapse gesture is detected, the first to seventh tab navigations 441 to 447 may be displayed according to the original order.

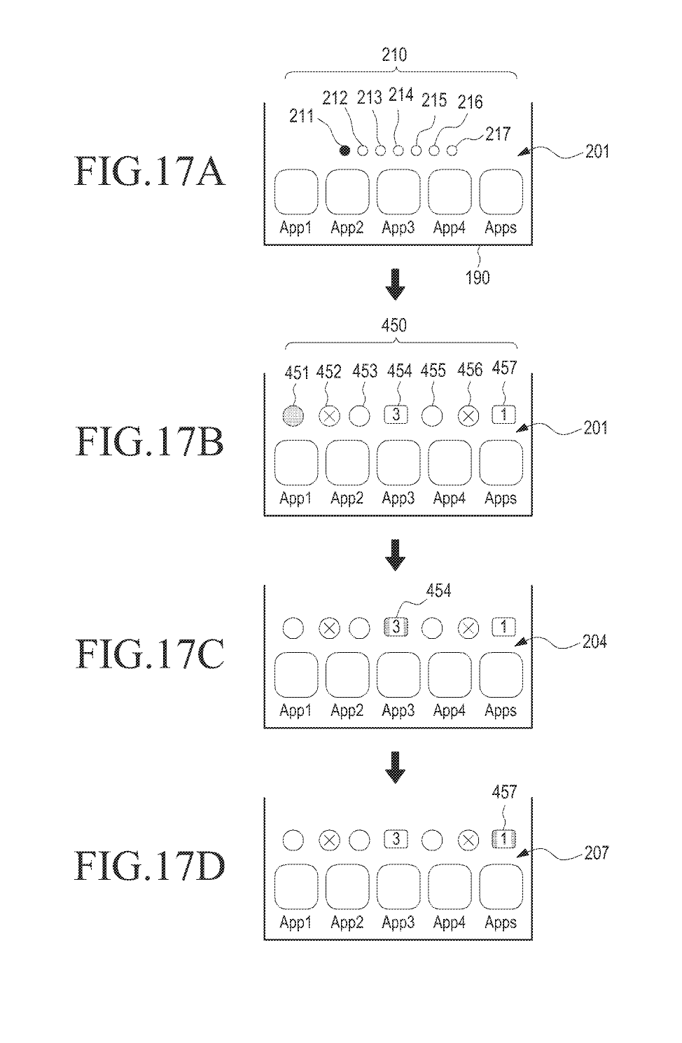

FIGS. 17A to 17D illustrate screens showing combined UI components according to a ninth example of the present disclosure.

Referring to FIGS. 17A to 17D, the controller 110 may display the first page 201 on the touch screen 190. The controller 110 may display the combined UI component 210 of the collapsed state including the one or more page indicators 211 to 217 on the touch screen. At this time, the first page indicator 211 corresponding to the first page may be deeply shaded. When the expansion gesture is detected, the controller 110 may change a state of the combined UI component 450 into the expanded state including one or more tab navigations 451 to 457 and may display the combined UI component of the expanded state on the touch screen. The expanded state may correspond to a rearrangement of the pages. The rearrangement may be a rearrangement according to the priority of the pages. For example, the priority may be determined such that a page with a larger number of notifications newly added after a predetermined time point has a higher priority. Further, the priority may be determined according to generating time of notifications newly added after a predetermined time point. The time point may correspond to a time point when the user lastly identifies the notification before the notification is generated, but the present disclosure is not limited thereto.

When the page switching gesture is detected, the page may be switched to the next page according to the order of the rearrangement and the next page may be displayed. Referring to FIG. 17B, a screen displaying the combined UI component 450 of the expanded state including the one or more tab navigations 451 to 447 is illustrated. The first to seventh tab navigations 451 to 457 corresponding to the first to seventh pages may be displayed. For example, in FIG. 17C, according to the priority in which the page having the larger number of newly added notifications has the higher priority, the fourth page has the largest number of newly added notifications corresponding to three and the seventh page has the next largest number of newly added notifications corresponding to one. Accordingly, when the page switching gesture is detected, the controller 110 may switch a page to the fourth page 204 and display the fourth page 204 as illustrated in FIG. 17C. When the page switching gesture is detected, the controller 110 may switch the page to the seventh page 207 and display the seventh page 207 as illustrated in FIG. 17D.

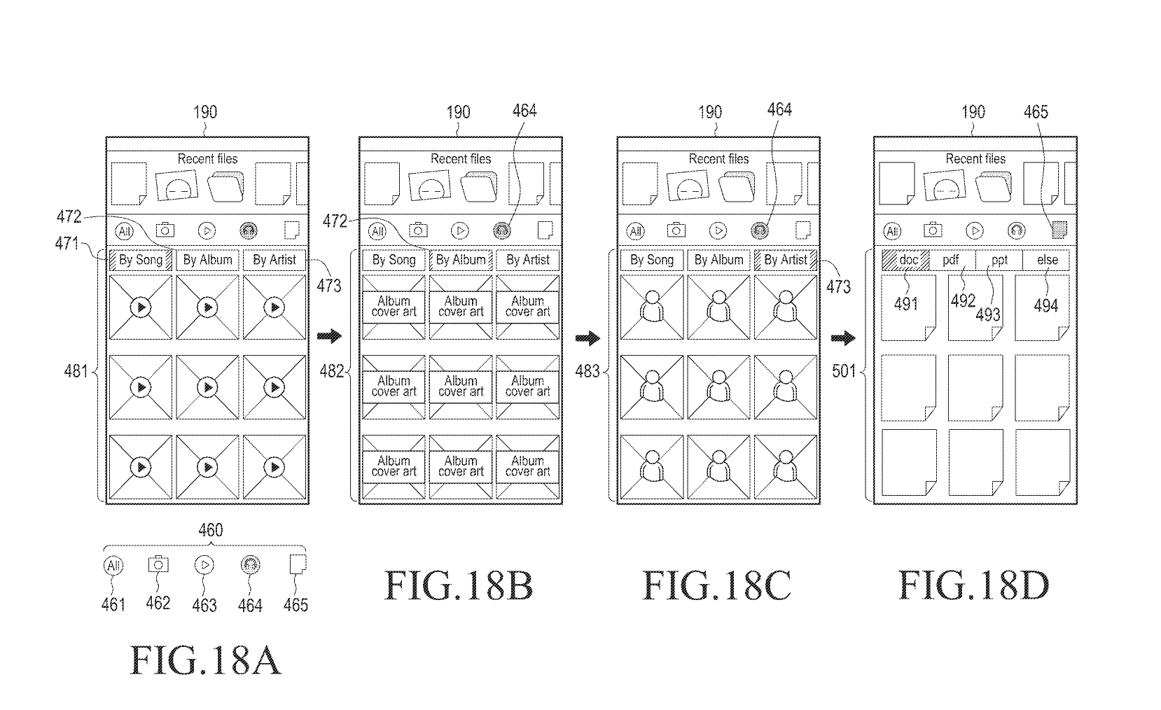

FIGS. 18A to 18D illustrate screens showing combined UI components according to a tenth example of the present disclosure.

Referring to FIGS. 18A to 18D, when the expansion gesture is detected, the controller 110 may change a state of the combined UI component into the expanded state including one or more tab navigations and display the combined UI component of the expanded state on the touch screen as illustrated in FIG. 18A. For example, the one or more tab navigations may be an all tab navigation, a photo tab navigation, a video tab navigation, a music tab navigation, and a doc tab navigation. As illustrated in FIG. 18A, when the music tab navigation 464 is selected, the fourth page including music content 481 corresponding to the music tab navigation may be displayed. However, the page may include a main depth page and a sub category page including a lower category of the main depth page. For example, as illustrated in FIG. 18A, the fourth page may include a sub category page including lower categories 471 to 473, such as “By Song”, “By Album”, and “By Artist”. Accordingly, as illustrated in FIG. 18A, when the lower category of “By song” is selected, the music content 481 may be displayed according to a song order. As illustrated in FIG. 18B, when the lower category of “By Album” is selected, music content 482 may be displayed according to an album order. As illustrated in FIG. 18C, when the lower category of “By Artist” is selected, music content 483 may be displayed according to an artist order. As illustrated in FIG. 18D, when the doc tab navigation 465 is selected, a main depth page, such as the fifth page including document content, may be displayed. The main depth page, such as the fifth page including the document content, may include a sub category page 501 including lower categories 491 to 494, such as “doc”, “pdf”, “ppt”, and “else”.

It will be appreciated that the various embodiments of the present disclosure may be implemented in a form of hardware, software, or a combination of hardware and software. Any such software may be stored, for example, in a volatile or non-volatile storage device such as a ROM, a memory such as a RAM, a memory chip, a memory device, or a memory Integrated Circuit, or a recordable optical or magnetic medium such as a CD, a DVD, a magnetic disk, or a magnetic tape, regardless of its ability to be erased or its ability to be re-recorded. A web widget manufacturing method of the present disclosure can be realized by a computer or a portable terminal including a controller and a memory, and it can be seen that the memory corresponds to an example of the storage medium which is suitable for storing a program or programs including instructions by which the various embodiments of the present disclosure are realized, and is machine readable. Accordingly, the present disclosure includes a program for a code implementing the apparatus and method described in the appended claims of the specification and a machine (a computer or the like)-readable storage medium for storing the program.

Further, the device can receive the program from a program providing apparatus connected to the device wirelessly or through a wire and store the received program. The program supply apparatus may include a program that includes instructions to execute the various embodiments of the present disclosure, a memory that stores information or the like required for the various embodiments of the present disclosure, a communication unit that conducts wired or wireless communication with the electronic apparatus, and a control unit that transmits a corresponding program to a transmission/reception apparatus in response to the request from the electronic apparatus or automatically.

While the present disclosure has been shown and described with reference to various embodiments thereof, it will be understood by those skilled in the art that various changes in form and details may be made therein without departing from the spirit and scope of the present disclosure as defined by the appended claims and their equivalent.

What is claimed is:

1. A method of controlling a portable device providing a combined User Interface (UI) component, the method comprising:
displaying a page on a touch screen;
displaying a combined UI component of a collapsed state including one or more page indicators on the touch screen;
detecting an expansion gesture for changing the combined UI component of the collapsed state into an expanded state; and
when the expansion gesture is detected, changing the combined UI component of the collapsed state into the expanded state and displaying the combined UI component of the expanded state on the touch screen.

2. The method of claim 1, wherein the expansion gesture corresponds to a touch or a hovering with respect to the page or the one or more page indicators.

3. The method of claim 1, wherein the expanded state is larger than the collapsed state, includes additional information, and/or has pages temporarily rearranged.

4. The method of claim 3, wherein the additional information includes at least one of an icon representing a type of content included in the page, a text indicating the type of content, a number of content, a number of notifications newly added to the page, a notification of a content newly added to the page, a number of content newly added to the page, and a notification of a content newly edited in the page.

5. The method of claim 1, further comprising:
detecting a page switching gesture for switching the page; and
when the page switching gesture is detected, switching the displayed page to a next page corresponding to the page switching gesture and displaying the next page on the touch screen.

6. The method of claim 5, wherein the page switching gesture corresponds to a touch or a hovering with respect to the page, the one or more page indicators, and/or one or more tab navigations.

7. The method of claim 1, further comprising:
detecting a collapse gesture for changing the combined UI component of the expanded state into the collapsed state; and
when the collapse gesture is detected, changing the combined UI component of the expanded state into the collapsed state and displaying the combined UI component of the collapsed state on the touch screen.

8. The method of claim 7, wherein the collapse gesture corresponds to at least one of a touch or a hovering with respect to the page or one or more tab navigations, no input for a preset time or longer, and an end of loading of content included in the page.

9. The method of claim 3, wherein the rearrangement corresponds to a temporary rearrangement of pages according to a priority.

10. The method of claim 9, wherein the priority is determined according to a number of notifications newly added to the page based on a predetermined time point.

11. The method of claim 9, wherein the priority is determined according to a generation order of notifications newly added to the page based on a predetermined time point.

12. The method of claim 1, wherein the page includes a main depth page and a sub category page including a lower category of the main depth page.

13. The method of claim 1, wherein the expanded state includes one or more tab navigations.

14. The method of claim 13, wherein the tab navigation is larger than the combined UI component.

15. The method of claim 13, wherein the tab navigation includes an icon representing a type of content included in the page or a text indicating the type of content.

16. The method of claim 13, wherein the tab navigation displays together at least two of an icon representing a type of content included in the page, a text indicating the type of content, and a number of content included in the page.

17. A portable device providing a combined User Interface (UI) component, the portable device comprising:
a controller configured to display a page on a touch screen, to display a combined UI component of a collapsed state including one or more page indicators on the touch screen, to detect an expansion gesture for changing the combined UI component of the collapsed state into an expanded state, and when the expansion gesture is detected, to change the combined UI component of the collapsed state into the expanded state and display the combined UI component of the expanded state on the touch screen; and
the touch screen configured to display the page.

18. The portable device of claim 17, wherein the expansion gesture corresponds to a touch or a hovering with respect to the page or the one or more page indicators.

19. The portable device of claim 17, wherein the expanded state is larger than the collapsed state, includes additional information, and/or has pages temporarily rearranged.

20. The portable device of claim 19, wherein the additional information includes at least one of an icon representing a type of content included in the page, text indicating the type of content, a number of content, a number of notifications newly added to the page, a notification of content newly added to the page, a number of content newly added to the page, and a notification of content newly edited in the page.

21. The portable device of claim 17, wherein the controller detects a page switching gesture for switching the page, switches the displayed page to a next page corresponding to the page switching gesture, and displays the next page on the touch screen when the page switching gesture is detected.

22. The portable device of claim 21, wherein the page switching gesture corresponds to at least one of a touch or a hovering with respect to the page, the one or more page indicators, and one or more tab navigations.

23. The portable device of claim 17, wherein the controller detects a collapse gesture for changing the combined UI component of the expanded state into the collapsed state, and
wherein, when the collapse gesture is detected, the controller changes the combined UI component of the expanded state into the collapsed state and displays the combined UI component of the collapsed state on the touch screen.

24. The portable device of claim 23, wherein the collapse gesture corresponds to at least one of a touch or a hovering with respect to the page or one or more tab navigations, no input for a preset time or longer, and an end of loading of a content included in the page.

25. The portable device of claim 19, wherein the rearrangement corresponds to a temporary rearrangement of pages according to a priority.

26. The portable device of claim 25, wherein the priority is determined according to a number of notifications newly added to the page based on a predetermined time point.

27. The portable device of claim 25, wherein the priority is determined according to a generation order of notifications newly added to the page based on a predetermined time point.

28. The portable device of claim 17, wherein the page includes a main depth page and a sub category page including a lower category of the main depth page.

29. The portable device of claim 17, wherein the expanded state includes one or more tab navigations.

30. The portable device of claim 29, wherein the tab navigation is larger than the combined UI component.

31. The portable device of claim 29, wherein the tab navigation includes at least one of an icon representing a type of content included in the page, text indicating the type of content, and a number of content included in the page.

32. The portable device of claim 29, wherein the tab navigation displays together at least two of an icon representing a type of content included in the page, text indicating the type of content, and a number of content included in the page.

33. A non-transitory computer readable medium storing instructions that, when executed, cause at least one processor to perform the method of claim 1.
